(19) United States
(12) Patent Application Publication
(10) Pub. No.: US 2004/0135995 A1
(43) Pub. Date: Jul. 15, 2004

(54) Spectroscopic ellipsometer wafer mapper for DUV to IR

(76) Inventors: James Lee Hendrix, Livermore, CA (US); David Y. Wang, Fremont, CA (US)

Correspondence Address: STALLMAN & POLLOCK LLP, Suite 290, 121 Spear Street, San Francisco, CA, 94105, US

(21) Appl. No.: 10/726,311

(22) Filed: Dec. 2, 2003

Related U.S. Application Data
(60) Provisional application No. 60/430,165, filed on Dec. 2, 2002.
(60) Provisional application No. 60/452,170, filed on Mar. 5, 2003.

(51) Int. Cl. G01N 21/00

(52) U.S. Cl. 356/237.2

(57) ABSTRACT

The present invention provides a wafer mapper for imaging large objects such as semiconductor wafers. In operation, the wafer mapper provides spectroscopic ellipsometric data or broadband ellipsometric data for the entire sample being analyzed. This data is provided via either a line scan or a wavelength scan and greatly reduces the time required to map an entire wafer in terms of film thickness, index of refraction, dielectric constant or other measurements.

### PRIORITY CLAIM

The present application claims priority to U.S. Provisional Patent Application Serial No. 60/430,165, filed Dec. 2, 2002 and U.S. Provisional Patent Application Serial No. 60/452,170, filed Mar. 5, 2003 both of which are incorporated in this document by reference.

### TECHNICAL FIELD

This subject invention relates to optical metrology tools that are configured to rapidly analyze large wafer areas at multiple wavelengths.

### BACKGROUND OF THE INVENTION

As semiconductor geometries continue to shrink, manufacturers have increasingly turned to optical techniques to perform non-destructive inspection and analysis of semiconductor wafers. Techniques of this type, known generally as optical metrology, operate by illuminating a sample with an incident field (typically referred to as a probe beam) and then detecting and analyzing the reflected energy off the sample. Ellipsometry and reflectometry are two examples of commonly used optical techniques. For the specific case of ellipsometry, changes in the polarization state of the probe beam are analyzed. Reflectometry is similar, except that changes in intensity are analyzed. Ellipsometry and reflectometry are effective methods for measuring a wide range of attributes including information about thickness, crystallinity, composition and refractive index. The structural details of ellipsometers are more fully described in U.S. Pat. Nos. 5,910,842 and 5,798,837 both of which are incorporated in this document by reference.

As shown in FIG. 1, a typical ellipsometer or reflectometer includes an illumination source that creates a monochromatic or polychromatic probe beam. The probe beam is focused by one or more lenses to create an illumination spot on the surface of the sample under test. A second lens (or lenses) images the illumination spot (or a portion of the illumination spot) to a detector. The detector captures (or otherwise processes) the received image. A processor analyzes the data collected by the detector. For systems with polychromatic probe beams, a spectrometer is typically present in front of the detector to disperse light into respective spectrum.

In production environments, each wafer is typically analyzed at a pre-determined pattern of locations or inspection sites. This is an important step in ensuring the quality of each of the many die that each wafer includes. This process is typically performed in a serial fashion. The wafer is moved (relative to the optical metrology system) to visit each site in turn. As each site is visited, the measurement process is performed and the results are gathered. The entire process is repeated until the entire pattern of inspections sites has been visited and measured. Unfortunately, this sequence of repeated movements and measurements tends to be relatively time-consuming. This is due is large part to the precision with which each inspection site must be located—a process that is typically performed by a human operator using a system of one or more optical microscopes. Although not generally debilitating, the time consumed during the measurement process can be a significant drawback in some environments.

For these reasons, a need exists for optical metrology systems that can rapidly measure multiple locations within semiconductor wafers. This need is particularly relevant for semiconductor applications where large wafers are used or applications that use a relatively large number of inspection locations.

One example of an approach that can obtain information across a scan line on a wafer is disclosed in US Patent Application 2002/0030826, incorporated herein by reference. The following disclosure represents different approaches for obtaining information over a large area of a wafer.

### SUMMARY OF THE INVENTION

The present invention provides a DUV to IR wafer mapper for analyzing large objects such as semiconductor wafers. For one embodiment, the wafer mapper progressively scans the sample under test. Scanning may be accomplished using a number of different patterns. Typically, however a progressive line scan is used in which a line of illumination is scanned over the surface of the sample. Reflected energy is collected for the scanned area and analyzed to determine properties such as film thickness, index of refraction, dielectric constant or other measurements. For typical cases, the illuminating energy is polychromatic light and the reflected energy is analyzed in terms of changes in magnitude (reflectometry) or change in polarization (ellipsometry).

For a second embodiment of the present invention, the wafer mapper illuminates a sample wafer (or a substantial portion of a wafer) at a single wavelength. The illuminating wavelength is then scanned through a predetermined range (or tuned to a series of different wavelengths). Reflected energy is collected at each illuminating wavelength and analyzed (both ellipsometry and reflectometry are supported) to determine sample properties such as film thickness, index of refraction, or dielectric constant.

### BRIEF DESCRIPTION OF THE DRAWINGS

FIG. 1 is a diagram of ellipsometer or reflectometer shown to describe the prior art of the present invention.

FIG. 2 is block diagram of a first embodiment of the wafer mapper of the present invention.

FIG. 3A is block diagram of a second embodiment of the wafer mapper of the present invention.

FIG. 3B is block diagram of a linear color filter suitable for use in the wafer mapper of FIG. 3A.

FIG. 3C is block diagram of a color wheel suitable for use in the wafer mapper of FIG. 3A.

FIG. 4 is block diagram of a third embodiment of the wafer mapper of the present invention.

FIGS. 5A and 5B show a first detection system suitable for use with the wafer mappers of FIGS. 2, 3, and 4.

FIGS. 6A through 6C show a second detection system suitable for use with the wafer mappers of FIGS. 2, 3, and 4.

FIGS. 7A and 7B show a third detection system suitable for use with the wafer mappers of FIGS. 2, 3, and 4.

### DETAILED DESCRIPTION OF THE PREFERRED EMBODIMENTS

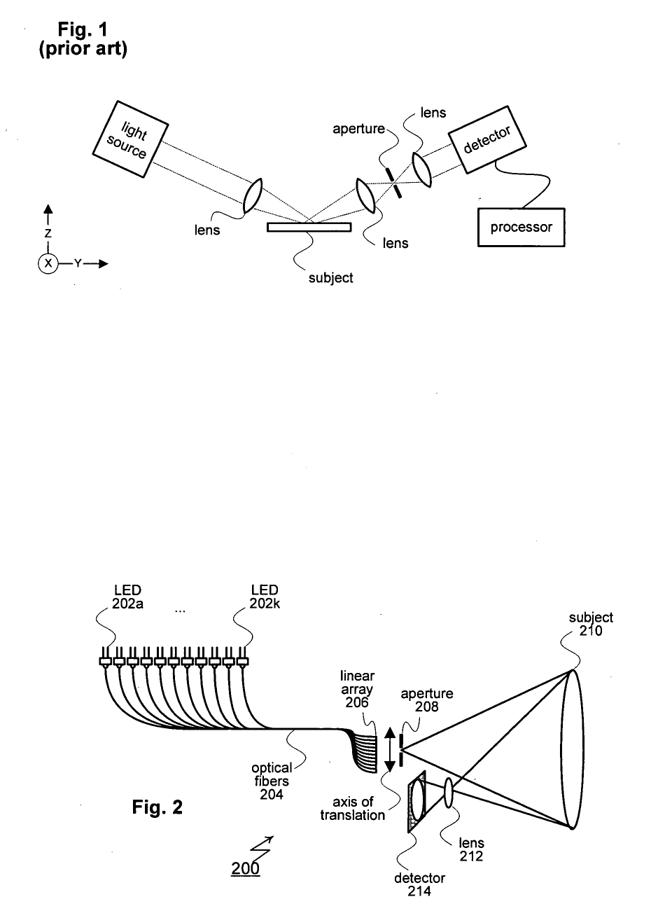

The present invention provides a wafer mapper for imaging large objects such as semiconductor wafers. Unlike traditional optical metrology systems which operate on small (local) portions of semiconductor wafers, the wafer mapper analyzes entire wafers (global or substantial wafer portions) and generates corresponding measurements. As shown in FIG. 2, a first embodiment of the wafer mapper 200 includes a series of illumination sources. For this particular example, the illumination sources are labeled 202a through 202k but any number of narrowband sources is practical. Each illumination source 202 is typically a light emitting diode (LED) but other sources may be used as well. Typically, each illumination source 202 produces light at a respective spectrum (where illumination sources 202 are polychromatic) or wavelength (where illumination sources 202 are monochromatic). For some implementations, sources 202 may cover the entire wavelength range over deep ultra-violet to near-infrared. For this type of implementation, sources 202 may contain UV-emitting lasers.

The outputs of the illumination sources 202 are transported using a bundle of optical fibers 204. Optical fibers 204 are arranged to position the outputs of illumination sources 202 as a linear array 206. The individual spectra of illumination sources 202 are reproduced by optical fibers 204 so that each point within linear array 206 corresponds to a different illumination source 202 and a spectrum.

An aperture 208 is positioned to control the light emitted by the linear array 206. The linear array 206 is movable (typically in translation) to select the output of a single fiber and a single illumination source 202. The output of the remaining fibers is blocked. The overall result is that a single spectrum (or wavelength) is selected at a time. By moving the linear array 206, each spectrum (or wavelength) is selected in succession.

Light from the selected fiber forms a cone of light that illuminates a sample 210. The illumination is global—a significant portion of sample 210 is illuminated. The shape of the light cone is governed by the numerical aperture of the fiber itself. For a doped, fused silica clad fused silica core fiber this angle is approximately 22 degrees. Thus, to illuminate a 300 mm semiconductor wafer the distance from the linear array to the wafer must be approximately 750-mm.

Light reflected by sample 210 light is collected by an imaging system, shown here as a lens 212, to form an image of the sample 210 on a CCD array or other two-dimensional array detector 214. The imaging process is repeated with the linear array 206 in one or more positions to gather images at one or more different wavelength ranges. That data can then be processed via the techniques of broadband and spectroscopic ellipsometry to determine the index of refraction of the film(s), dielectric constant or thickness. The data obtained by the pixels of the CCD can be mapped to locations over the entire wafer surface.

For some implementations, the output of the illumination sources 202 may be controlled electronically to select a single illumination source 202 at a time. For this type of implementation, the linear array 206 may be replaced by a multi-input, single-output fixedposition fiber that combines light from optical fibers 204 into a single source and could be laid out in any suitable fashion, such as a circle or square pattern.

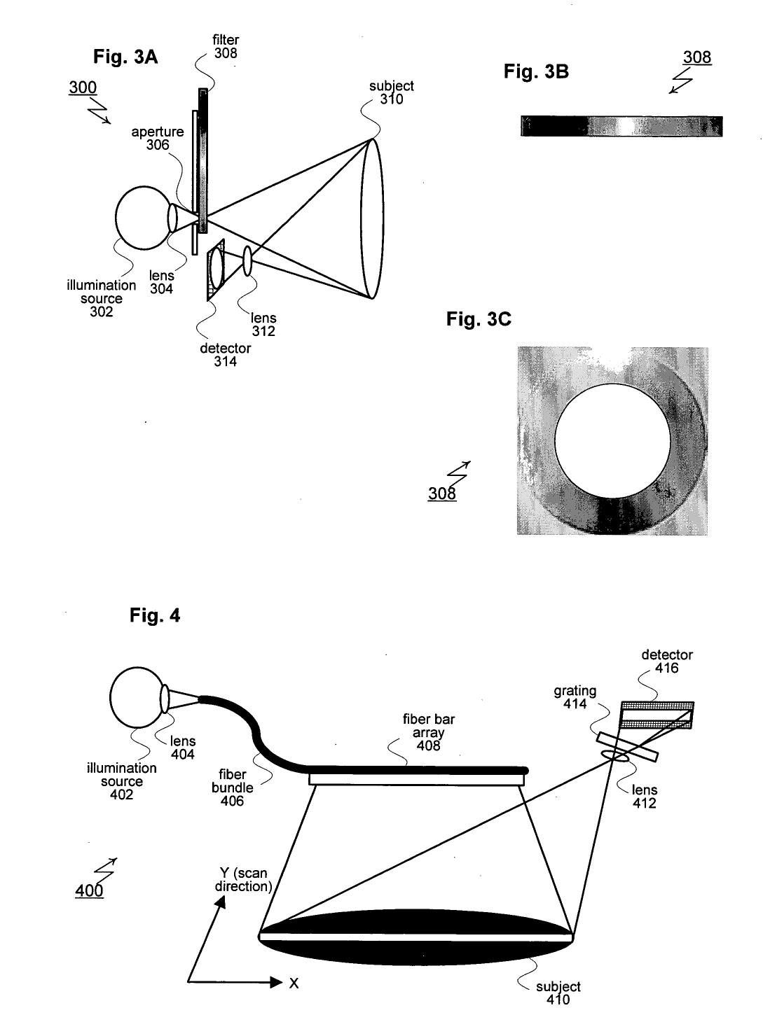

As shown in FIG. 3A, a second embodiment of the wafer mapper 300 includes a broadband illumination source 302 such as a Xenon or Halogen source. The output of illumination source 302 is collected using one or more lenses 304 and projected through an aperture 306. A color filter 308 follows aperture 306. Color filter 306 may be a linear filter as shown in FIG. 3B or a color wheel as shown in FIG. 3C. After leaving color filter 308, the colorized or filtered light illuminates a sample 310. The illumination is global—a significant portion of sample 310 is illuminated.

Sample 310 reflects the colorized light and the reflected light is collected by an imaging system, shown here as a lens 312, to form an image of sample 310 on a CCD array or other detector 314. The imaging process is repeated with the color filter 308 in one or more positions to gather images at one or more different wavelengths. That data can then be processed via the techniques of broadband and spectroscopic ellipsometry to determine the index of refraction of the film(s), dielectric constant and thickness.

As an alternative to the color filter, the light from the source could be passed through a monochrometer for selecting particular wavelengths of light. The monochrometer can include a dispersive element such as a grating or a prism and an aperture.

As shown in FIG. 4, a third embodiment of the wafer mapper 400 includes a broadband illumination source 402 such as a Xenon or Halogen source. The output of illumination source 402 is through a lens 404 and into a fiber bundle 406. The output of illumination source 402 passes through fiber bundle 406 to a fiber bar array 408 where it is projected to form a line on a sample 410. The reflected light is collected by an imaging system, shown here as a lens 412, and passed through (or off of) a grating 414 before reaching a CCD array or other detector 416. Grating 414 creates a two-dimensional image on at the detector 416. One axis of the two-dimensional image includes spatial information while the second axis includes spectral information. Sample 410 is stepped to scan the line across the entire wafer surface. Alternately, sample 410 may remain motionless and fiber bar array 408 moved, either in translation or by pivoting to perform the scan operation.

In an alternative to the FIG. 4 embodiment, it is possible to time multiplex multiple narrowband illumination sources. This is similar to the case where time multiplexing is used with the multiple sources of FIG. 2. In this case, there would be no need for grating 414 and the detector could be a linear array.

In another alternative to the FIG. 4 embodiment, a variable color filter of the type shown in FIG. 3 could be used. In this case, there would be no need for grating 414 and the detector could be a linear array.

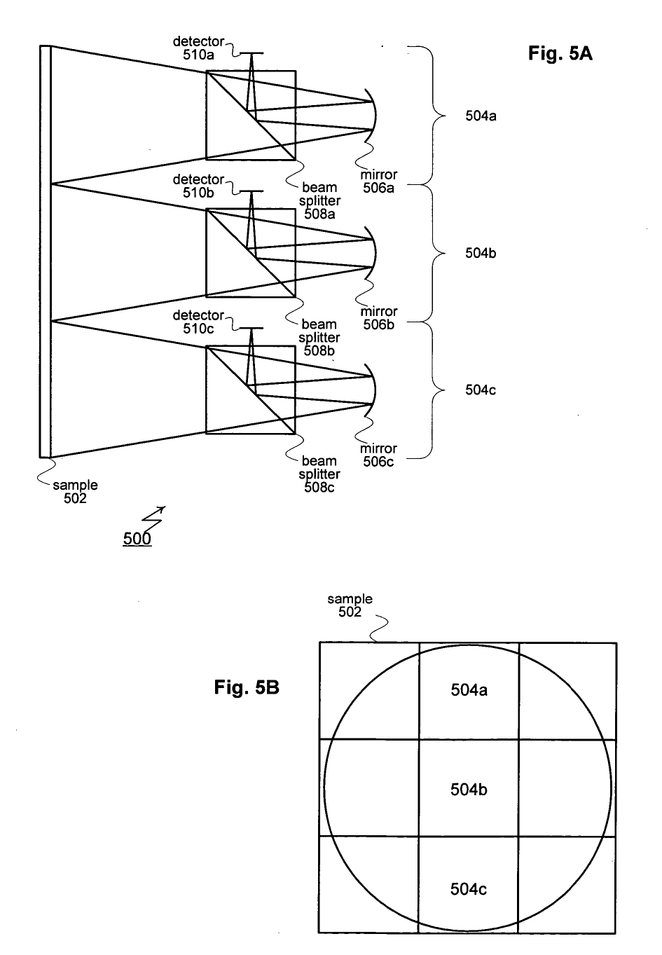

FIG. 5A shows a detection system 500 suitable for use with any of the embodiments described above. As shown, detection system 500 uses an array of detection optics (504a through 504c for this example) to image a sample wafer 502. As shown in FIG. 5B, each detection optic 504 views a two-dimensional segment of wafer 502. Each detection optic 504 includes a spherical mirror 506, a cubical beam splitter 508 and a detector array 510. Spherical mirrors 506 collect light reflected by sample 502. The collected light is directed by beam splitters 508 to detector arrays 510. In addition to supplying detector arrays 510, the combination of beam splitters 508 and spherical mirrors 506 collapses the path length used in detection system 500.

In another alternate to FIG. 5A, spherical mirror 506 and cube beam splitter 508 in detector optic 504 are replaced by a lens array. The lens array collects light reflected off the sample 502, at multiple discreet points over sample 502. The collected light is directed to detector arrays 510. In this type of implementation, lens diameter controls the sampling frequency at sample 502 and lens NA controls spatial resolution of the image. Lens array implementations may be implemented using lithographic techniques which, increases, in many cases the density with which the individual lenses are grouped.

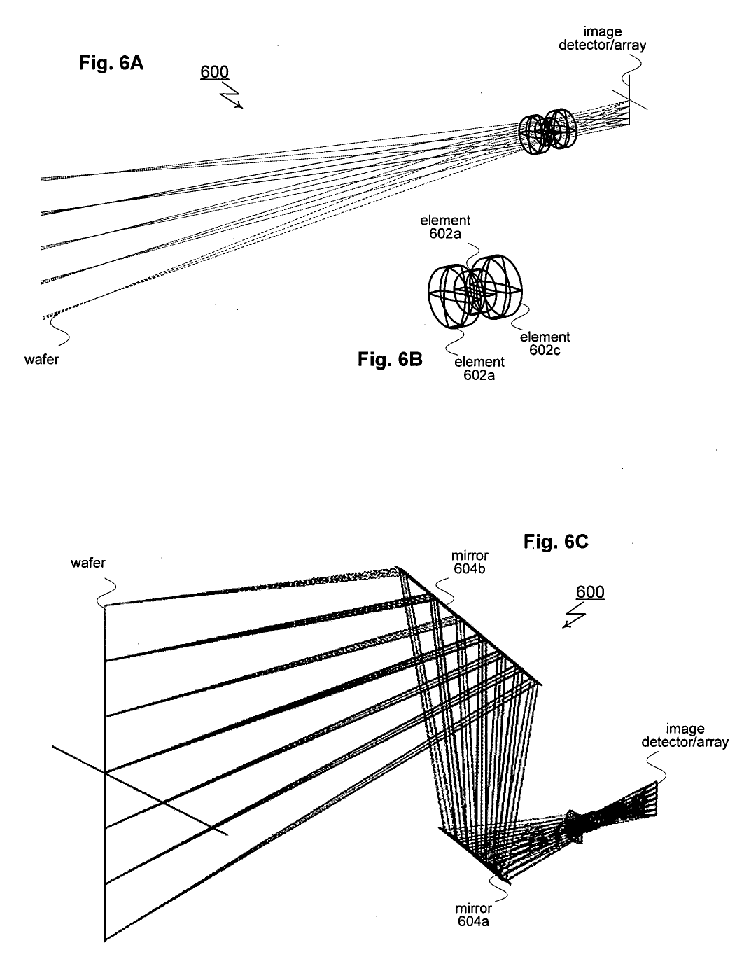

FIG. 6A shows a second detection system 600 suitable for use with any of the embodiments described above. As shown, detection system 600 includes one or more refractive optical elements 602. The individual optical elements 602a through 602c are shown more clearly in FIG. 6B. FIG. 6C shows detection system 600 used in combination with reflective elements 602a and 602b. Reflective elements 604 fold the beam path of detection system 600, reducing its physical size.

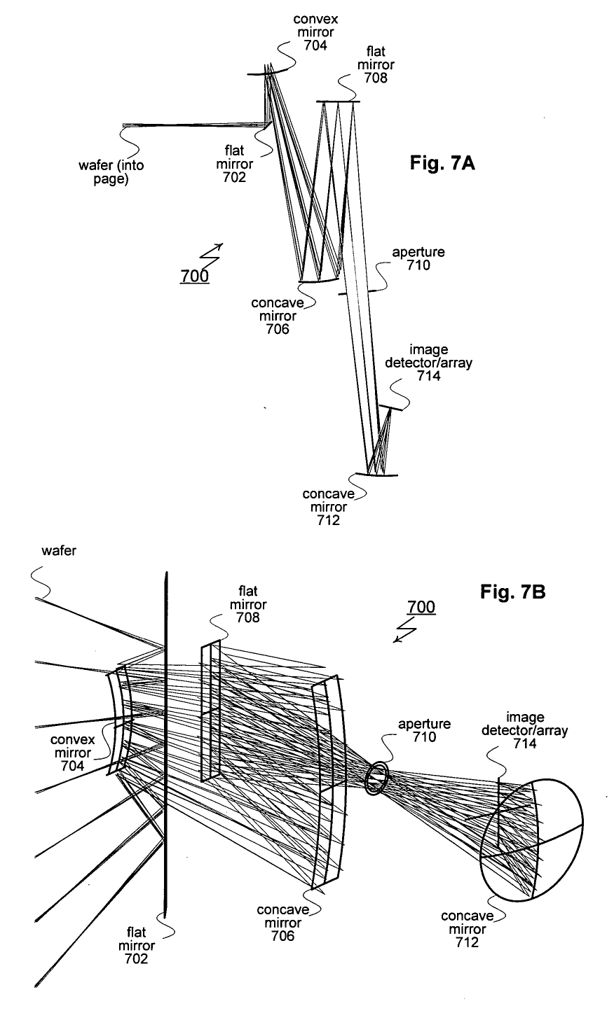

FIGS. 7A and 7B shows a third detection system 700 suitable for use with any of the embodiments described above. As shown, detection system 700 uses reflective optical elements. Detector system 700 includes a flat mirror 702 for gathering energy reflected by a sample (sample not shown). The energy gathered by mirror 702 is projected to a sequence that includes a convex mirror 704 followed by a concave mirror 706, a flat mirror 708, an aperture 710 and a concave mirror 712. Concave mirror 712 is followed by a detector 714. Mirrors 704, 706 and 712 set system magnification. Mirrors 704 and 708 fold the system for packaging purposes. FIG. 7B is a perspective view of FIG. 7A.

What is claimed is:

1. A method of optically inspecting and evaluating a sample, the method comprising the steps of:
repeatedly illuminating a substantial portion of the sample at a succession of spectral ranges;
gathering the illumination reflected by the substantial portion of the sample at each spectral range; and
analyzing the gathered illumination to generate a measurement describing a physical property of the sample.

2. A method as recited in claim 1 that further comprises the steps of:
generating a probe beam using a broad spectrum illumination source; and
colorizing the probe beam by passing it through a selected portion of a variable color filter.

3. A method as recited in claim 1 that further comprises the step of: illuminating the sample by enabling one of a series of illumination sources where each illumination source produces light within a respective spectral range.

4. A method as recited in claim 1, wherein the step of gathering the illumination reflected by the substantial portion of the sample is performed using a series of optical systems, each configured to gather illumination reflected by a respective sample portion.

5. A device for optically inspecting and evaluating a sample, the device comprising:
a plurality of individual light sources each emitting light at a different spectral range:
a plurality of optical fibers, each associated with a respective light source;
means for selectively transmitting light emitted from one of the fibers to illuminate a large area of the sample;
a detector having an array of elements configured to measure light reflected from the sample, the elements generating output signals that can be mapped to particular measurement regions on the sample; and
a processor for evaluating characteristics of the sample based on the output signals.

6. A device as recited in claim 5, wherein the entire sample is illuminated.

7. A device for optically inspecting and evaluating a sample, the device comprising:
a broadband light source;
a filter for selectively transmitting a narrow spectral range of light, wherein the transmitted light is used to illuminate a large area of a sample;
a detector having an array of elements configured to measure light reflected from the sample, the elements generating output signals that can be mapped to particular measurement regions on the sample; and
a processor for evaluating characteristics of the sample based on the output signals.

8. A device as recited in claim 7, including a means for adjusting the filter to transmit successive, different spectral ranges of light.

9. A device as recited in claim 7, wherein the entire sample is illuminated.

10. A device as recited in claim 7, wherein the illuminated area is in the shape of an extended rectangle.

11. A method of optically inspecting and evaluating a sample, the method comprising the steps of:
(a) illuminating the sample by enabling one of a series of illumination sources, where each illumination source produces light within a respective spectral range;
(b) gathering an image of the sample illuminated by the enabled illumination source; and
(c) repeating steps a and b while changing the selected illumination source to gather a series of images of the sample illuminated by a series of spectral ranges.

12. A device for optically inspecting and evaluating a sample, the device comprising:
an illumination system for illuminating a large area of the sample;
a dense array of micro lenses, each lens configured to gather light reflected by a particular measurement regions on the sample;
a series of detectors each paired with a respective micro lens and measurement region, each detector creating an output signal corresponding to its measurement region; and
a processor for evaluating characteristics of the sample based on the output signals.

13. A device as recited in claim 12, wherein the illumination system comprises:
a plurality of individual light sources each emitting light at a different spectral range:
a plurality of optical fibers, each associated with a respective light source; and
means for selectively transmitting light emitted from one of the fibers to illuminate a large area of the sample.

14. A device as recited in claim 12, wherein the illumination system comprises:
a broadband light source; and
a filter for selectively transmitting a narrow spectral range of light, wherein the transmitted light is used to illuminate a large area of a sample.
